(19) United States
(12) Patent Application Publication
(10) Pub. No.: US 2009/0009685 A1
(43) Pub. Date: Jan. 8, 2009

(54) POLARIZER AND LIQUID CRYSTAL DISPLAY HAVING THE SAME

(75) Inventors: Sang-Yong NO, Seoul (KR); Sun-Hyung KIM, Seoul (KR); Jong-Hwan LEE, Anyang-si (KR); Beom-Jun KIM, Seoul (KR); Bong-Jun LEE, Seoul (KR); Hong-Woo LEE, Cheonan-si (KR); Shin-Tack KANG, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/168,419

(22) Filed: Jul. 7, 2008

(30) Foreign Application Priority Data
Jul. 5, 2007 (KR) 10-2007-0067624

(51) Int. Cl. G02F 1/13357; G02F 1/1335

(52) U.S. Cl. 349/62; 349/96

(57) ABSTRACT

A liquid crystal display includes a backlight unit, a liquid crystal display panel, and first and second polarizers. The first polarizer is attached to a lower portion of the liquid crystal display panel to face the backlight unit, and the second polarizer is attached to an upper portion of the liquid crystal display panel to correspond to the first polarizer. The liquid crystal display panel includes a first optical layer that partially reflects light provided from the backlight unit, and the first polarizer includes a second optical layer to prevent the light reflected by the first optical layer from being re-reflected to the liquid crystal display panel.

### CROSS-REFERENCE TO RELATED APPLICATION

This application claims priority from and the benefit of Korean Patent Application No. 10-2007-0067624, filed on Jul. 5, 2007, which is hereby incorporated by reference for all purposes as if fully set forth herein.

### BACKGROUND OF THE INVENTION

1. Field of the Invention

The present invention relates to a polarizer and a liquid crystal display including the polarizer. More particularly, the present invention relates to a polarizer that may improve display quality and a liquid crystal display including the polarizer.

2. Discussion of the Background

In general, a liquid crystal display displays an image using liquid crystals and a light source. A liquid crystal display may include a liquid crystal display panel having liquid crystals and a polarizer attached to the liquid crystal display panel. Also, the liquid crystal display includes a light-emitting device to generate and provide light to the liquid crystal display panel and the polarizer since the liquid crystals are not self-emissive.

The polarizer may include various optical films, including a polarizing film, to perform various functions. The liquid crystal display panel may include two substrates facing each other with liquid crystals disposed therebetween and various thin film patterns disposed between the two substrates. Accordingly, light is provided to the polarizer and the liquid crystal display panel after passing through various optical films and thin film patterns. Light may be reflected or refracted by the optical films or thin film patterns, which may deteriorate the display quality of the liquid crystal display due to the optical functions of the films.

### SUMMARY OF THE INVENTION

The present invention provides a polarizer that may improve display quality.

The present invention also provides a liquid crystal display having the polarizer.

Additional features of the invention will be set forth in the description which follows, and in part will be apparent from the description, or may be learned by practice of the invention.

The present invention discloses a polarizer includes a polarizing film, a brightness-enhancement film, and a low-reflection layer. The polarizing film polarizes a light. The brightness-enhancement film is coupled to the polarizing film to enhance a brightness of the light. The low-reflection layer is coupled to the brightness-enhancement film to prevent the light from being re-reflected back to the polarizing film.

The present invention also discloses a liquid crystal display including a backlight unit, a liquid crystal display panel, a first polarizer, and a second polarizer. The liquid crystal display panel comprises a first optical layer that partially reflects light. The first polarizer comprises a second optical layer. The backlight unit generates a light. The liquid crystal display panel receives light and displays an image. The first polarizer is coupled to a lower portion of the liquid crystal display panel to face the backlight unit. The second polarizer is coupled to an upper portion of the liquid crystal display panel to correspond to the first polarizer. The second optical layer prevents the reflected light by the first optical layer from being re-reflected back to the liquid crystal display panel.

The present invention also discloses a liquid crystal display panel including a first substrate, a gate line, a data line, a second substrate, a light-blocking layer pattern, and a liquid crystal layer. The first substrate includes a pixel area defined thereon and the first polarizer is coupled to the first substrate. The gate line is disposed on the first substrate. The data line crosses the gate line to define the pixel area. The second substrate is provided with the second polarizer coupled thereto. The light-blocking layer pattern is disposed on the second substrate and positioned in regions corresponding to the gate line and the data line. The liquid crystal layer is interposed between the first substrate and the second substrate. The first optical layer is disposed on the same layer as the gate line, and the data line completely overlaps the first optical layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a sectional view showing a liquid crystal display according to an exemplary embodiment of the present invention.

FIG. 2 is a photograph showing vertical-striped patterns on a conventional liquid crystal display.

FIG. 3A and FIG. 3B are sectional views showing a first substrate and a first polarizer attached to the first substrate of FIG. 1 in order to illustrate a vertical striped pattern.

FIG. 4 is a sectional view showing a low-reflection layer in a liquid crystal display according to the exemplary embodiment of FIG. 1.

FIG. 5A, FIG. 5B, and FIG. 5C are sectional views of various different types of first polarizers that may be applied to the liquid crystal display of FIG. 1, according to exemplary embodiments of the present invention.

FIG. 6A to FIG. 6C are sectional views of various different types of low-reflection layers that may be applied to the first polarizers of FIG. 5A and FIG. 5B, according to exemplary embodiments of the present invention.

FIG. 7 is a perspective view showing a brightness enhancement film applied to the first polarizer of FIG. 5C.

FIG. 8 is a sectional view showing a second polarizer of FIG. 1.

FIG. 9 is a perspective view showing a liquid crystal display panel of FIG. 1.

FIG. 10 is a plan view showing a liquid crystal display according to another exemplary embodiment of the present invention.

FIG. 11A is a cross-sectional view taken along line I-I′ of FIG. 10.

FIG. 11B is a cross-sectional view taken along line II-II′ of FIG. 10.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to”, or “coupled to” another element or layer, it can be directly on, connected to, or coupled to the other element or layer or intervening elements or layers may be present. In contrast, when an element is referred to as being “directly on”, “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

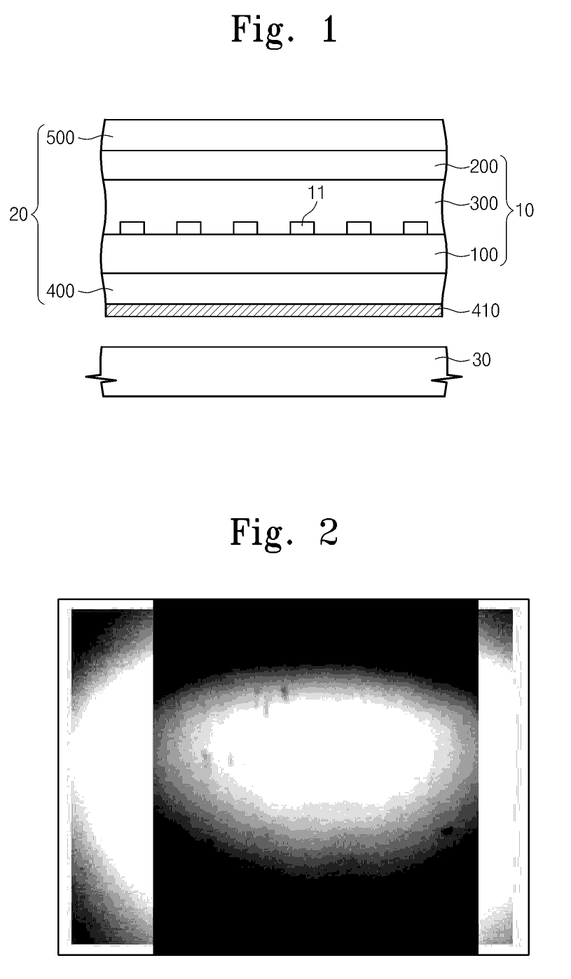

FIG. 1 is a sectional view showing a liquid crystal display according to an exemplary embodiment of the present invention.

Referring to FIG. 1, a liquid crystal display includes a liquid crystal display panel 10, a polarizer 20, and a backlight unit 30. The liquid crystal display panel 10 includes two substrates facing each other. In the present exemplary embodiment, a substrate positioned at a lower portion is referred to as the first substrate 100 and a substrate positioned at an upper portion is referred to as the second substrate 200. The liquid crystal display panel 10 further includes a liquid crystal layer 300, in which liquid crystals are arranged, interposed between the first and second substrates 100 and 200.

The polarizer 20 is attached to the liquid crystal display panel 10. The polarizer 20 includes a first polarizer 400 attached to the first substrate 100 and a second polarizer 500 attached to the second substrate 200. The first polarizer 400 is positioned at a lower portion adjacent to the backlight unit 30, and the second polarizer 500 is positioned at an uppermost portion of the liquid crystal display and outwardly exposed.

The first and second polarizers 400 and 500 each have a transmission axis and are arranged to allow the transmission axis of the first polarizer 400 to be perpendicular to the transmission axis of the second polarizer 500. When light is provided from the backlight unit 30, the light is linearly polarized by the first polarizer 400 and absorbed by the second polarizer 500. However, since the linearly polarized light by the first polarizer 400 may vary its polarization state while passing through the liquid crystal layer 300, the light that is linearly polarized by the first polarizer 400 may pass through the second polarizer 500. The variation of the polarization state depends on the arrangement of the liquid crystals in the liquid crystal layer 300. Thus, the liquid crystal display controls the arrangement of the liquid crystals using electrical signals to adjust an amount of the light passing through the second polarizer 500, thereby displaying a desired image.

In order to perform the polarizing process, the first and second substrates 100 and 200 are provided with various thin film patterns formed thereon. In FIG. 1, an inner structure of the liquid crystal display panel 100 has been simply shown, and one thin film pattern among various thin film patterns has been described. Although the thin film pattern 11 of FIG. 1 is disposed on the first substrate 100, the thin film pattern 11 may alternatively be disposed only on the second substrate 200 or on both the first and second substrates 100 and 200. The thin film pattern 11 may be opaque to reflect light incident thereto. The reflected light advances toward the first polarizer 400.

The first polarizer 400 includes a low-reflection layer 410. The low-reflection layer 410 prevents light from advancing to the liquid crystal display panel 100 after light being reflected from the thin film pattern towards the first polarizer 400. As described hereinafter, when re-reflected light advances to the liquid crystal display panel 100, the display quality of the liquid crystal display may deteriorate due to the re-reflected light. Therefore, the low-reflection layer 410 prevents light from being re-reflected, which may improve the display quality of the liquid crystal display.

FIG. 2 is a photograph showing vertical-striped patterns on a conventional liquid crystal display.

Referring to FIG. 2, the vertical-striped patterns appear in a region that is displayed brightly. The vertical-striped patterns regularly appear on conventional liquid crystal display panels, which suggests that the vertical-striped patterns are caused by parts regularly arranged in conventional liquid crystal displays.

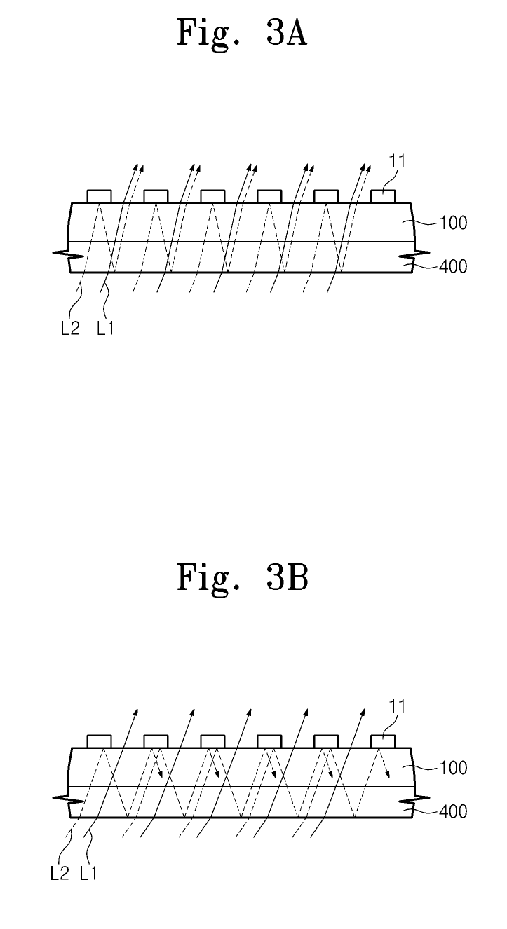

FIG. 3A and FIG. 3B are sectional views showing a first substrate and a first polarizer attached on the first substrate of FIG. 1 in order to illustrate a vertical striped pattern. For convenience of explanation, the first polarizer 400 to which the low-reflection layer 410 is not attached will be described in FIG. 3A and FIG. 3B as an example.

Referring to FIG. 3A, the light incident into the first polarizer 400 includes a first light L1 and a second light L2 according to its advance path. The first light L1 advances through the first polarizer 400 and the first substrate 100. The path of the first light L1 is changed due to a medium difference between the first polarizer 400 and the first substrate 100. The path of the first light L1 may change when passing through an inner portion of the first polarizer 400 and through an inner portion of first substrate 100. The change of the path of the first light L1 may be small since the medium difference in each inner portion of the first polarizer 400 and the first substrate 100 may be small.

The second light L2 passes through the first polarizer 400 and the first substrate 100, and the second light L2 is reflected by the thin film pattern 11. After the reflection of the second light L2, the second light L2 is re-reflected from the first polarizer 400. After the re-reflection of the second light L2, the second light L2 advances through the first polarizer 400 and the first substrate 100. As a result, the image having improved brightness may be displayed on the liquid crystal display panel 100 by the first and second lights L1 and L2.

Referring to FIG. 3B, the first light L1 advances through the first polarizer 400 and the first substrate 100. The second light L2 is reflected by the thin film pattern 11 after passing through the first polarizer 400 and the first substrate 100. After the second light L2 is reflected, the second light L2 is re-reflected by the first polarizer 400. After the second light L2 is re-reflected, the second light L2 is repeatedly reflected between the thin film pattern 11 and the first polarizer 400. The second light L2 may not be emitted from the first substrate 100 due to its repeated reflection, so an image having reduced brightness may be displayed.

As shown in FIG. 3A and FIG. 3B, the light reflected by the thin film pattern II is re-reflected by the first polarizer 400, and the re-reflected light may be outwardly emitted (FIG. 3A) or not (FIG. 3B). The vertical-striped patterns are caused by a difference in brightness between the portion of the second light that is outwardly emitted and the portion of the second light that is not outwardly emitted.

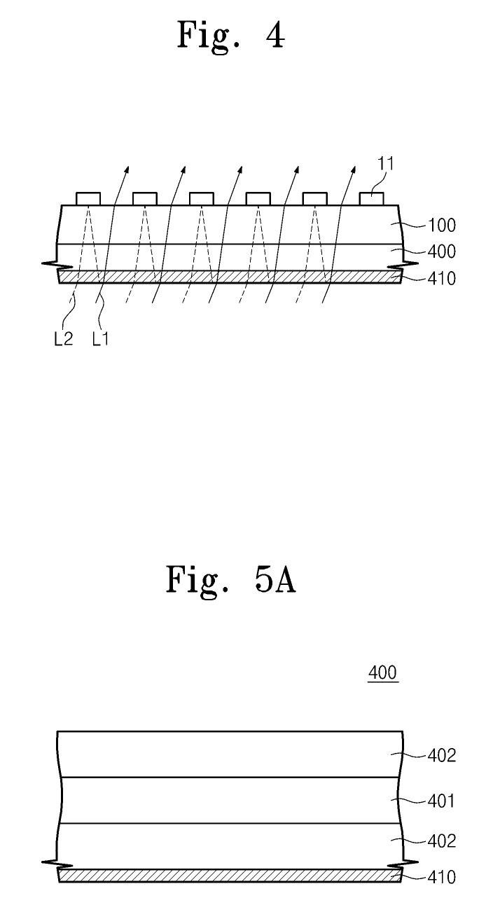

FIG. 4 is a sectional view showing a low-reflection layer in a liquid crystal display according to the exemplary embodiment of FIG. 1.

Referring to FIG. 4, a light incident into the first polarizer 400 includes a first light L1 and a second light L2 according to its advance path. The first light L1 advances through the first polarizer 400 and the first substrate 100. The path of the first light L1 is changed by a medium difference between the first polarizer 400 and the first substrate 100.

The second light L2 passes through the first polarizer 400 and the first substrate 100, and the second light L2 is reflected by the thin film pattern 11. After the second light L2 is reflected, the second light L2 is incident into the first polarizer 400. The low-reflection layer 410 prevents the re-reflection of the second light L2 by the first polarizer 400, which prevents the second light L2 from advancing to the liquid crystal display panel 100. Consequently, the second light L2 may disappear inside the first polarizer 400, so the liquid crystal display may display an image only using the first light L1. The image has a uniform brightness corresponding to the first light L1 and may be a high quality image from which the vertical-striped patterns are removed. The low-reflection layer 410 may prevent the second light L2 from advancing to the liquid crystal display panel 100 again by employing various means.

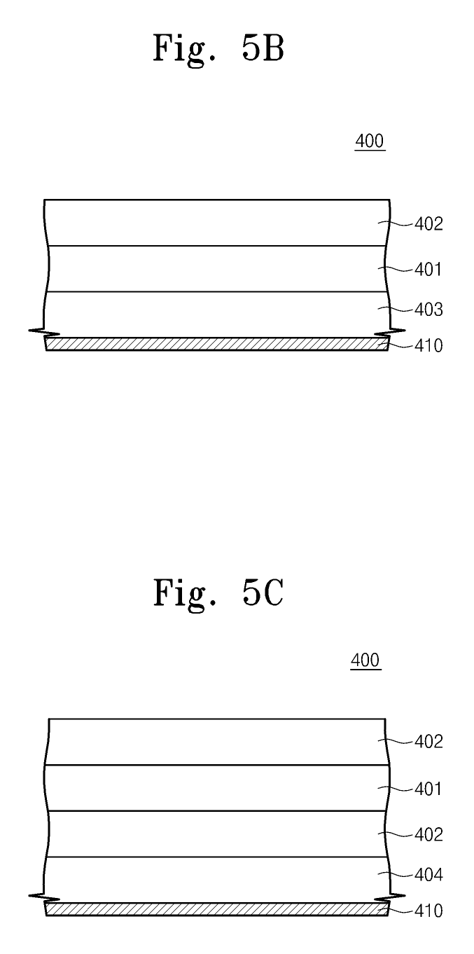

FIG. 5A, FIG. 5B, and FIG. 5C are sectional views showing different types of first polarizers that may be applied to the liquid crystal display of FIG. 1, according to exemplary embodiments of the present invention.

Referring to FIG. 5A, the first polarizer 400 includes a first polarizing film 401, a first supporting film 402, and the low-reflection layer 410. The first polarizing film 401 polarizes the light. The first polarizing film 401 may be an optical film having a polyvinylalcohol (PVA) material that is dyed with iodine (I) and elongated in one direction. Thus, a direction perpendicular to the elongated direction of the optical film serves as the transmission axis of the first polarizing film 401.

The first supporting film 402 supports the first polarizing film 401. The first supporting film 402 has durability allowing the first polarizing film 401 to have mechanical strength, heat resistance, moisture resistance, etc. The first supporting film 402 may include triacetate cellulose (TAC). The polarizer 400 includes a pair of first supporting films 402 and the first polarizing film 401 is disposed between the first supporting films 402.

The low-reflection layer 410 is disposed on the first supporting film 402 attached to a lower face of the first polarizing film 401. The low-reflection layer 410 is attached to the first supporting film 402 after the low-reflection layer 410 is formed using a separate optical film, or is coated over the lower face of the first supporting film 402. The low-reflection layer 410 prevents the reflection of the light therefrom using various physical/chemical members. For example, the low-reflection layer 410 may prevent the reflection of the light using various patterns, such as a lattice pattern, an embossing pattern, etc., formed on a surface thereof or inside the low-reflection layer 410. The low-reflection layer 410 may also prevent the reflection of the light using diffused reflection caused by a particles diffused in the low-reflection layer 410.

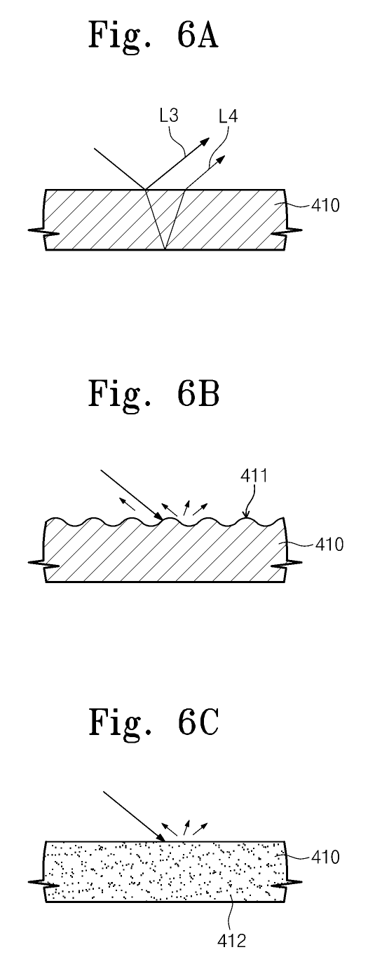

FIG. 6A to FIG. 6C are sectional views showing various embodiments of a low-reflection layer applied to the first polarizer of FIG. 5A and FIG. 5B.

Referring to FIG. 6A, light advancing to the low-reflection layer 410 after being reflected from the thin film pattern 11 may be reflected from an upper face of the low-reflection layer 410 or incident into the low-reflection layer 410. For the convenience of the explanation, light reflected from the upper face of the low-reflection layer 410 is defined as a third light L3, and light incident into the low-reflection layer 410 is defined as a fourth light L4. The fourth light L4 is reflected from a lower face of the low-reflection layer 410. The fourth light L4 exits from the upper face of the low-reflection layer 410 and interferes with the third light L3.

The low-reflection layer 410 causes a phase difference in the light passing therethrough. For instance, when the low-reflection layer 410 causes a phase difference of about ¼ wavelength, a phase difference of ¼ wavelength occurs in the fourth light L4 while the fourth light L4 advances from the upper face to the lower face of the low-reflection layer 410, and a phase difference of about ¼ wavelength occurs again in the fourth light L4 while the fourth light L4 advances from the lower face to the upper face of the low-reflection layer 410. Accordingly, the fourth light L4 has a phase difference of about ½ wavelength while advancing through the low-reflection layer 410, and the third and fourth lights L3 and L4 interfere with each other and then disappear.

Referring to FIG. 6B and FIG. 6C, light advancing to the low-reflection layer 410 after reflecting by the thin film pattern 11 is scattered at the upper face of the low-reflection layer 410. Thus, light is dispersed in various directions, so that the intensity of the light may be weakened. In other words, the scattered light may not be recognized outside of the liquid crystal display, which may prevent the vertical striped patterns from appearing on the liquid crystal display. In order to scatter the light, the low-reflection layer 410 may include concavo-convex portions 411 disposed thereon, scattering particles 412 inside the low-reflection layer 410, or both the concavo-convex portions 411 and the scattering particles 412.

The scattering members for the low-reflection layer 410 are not limited to the above-mentioned members. Rather, various members that may scatter the light may be applied to the low-reflection layer 410.

Referring to 5B, the first polarizer 400 includes a first polarizing film 401, a first supporting film 402, a compensation film 403, and a low-reflection layer 410. The first polarizing film 401 has a transmission axis and polarizes light in a direction parallel to the transmission axis. The first supporting film 402 is attached to the upper face of the first polarizing film 401 and supports the first polarizing film 401. The compensation film 403 faces the first supporting film 402 with the first polarizing film 401 disposed therebetween. The compensation film 403 widens a side viewing angle of the liquid crystal display. The compensation film 403 supports the first polarizing film 401 with the first supporting film 402. The low-reflection layer 410 is disposed on a lower face of the compensation film 403 and prevents light, which is incident to the low-reflection layer 410, from being reflected using various physical/chemical members.

Referring to FIG. 5C, a first polarizer 400 includes a first polarizing film 401, a first supporting film 402, a brightness-enhancement film 404, and a low-reflection layer 410. The first polarizing film 401 polarizes the light, and the first supporting film 402 supports both sides of the first polarizing film 401.

The brightness-enhancement film 404 enhances the brightness of the liquid crystal display. That is, the brightness-enhancement film 404 transmits light parallel to the transmission axis of the first polarizer 400, and transmits light vertical to the transmission axis of the first polarizer 400 after changing the light vertical to the transmission axis into the light parallel to the transmission axis.

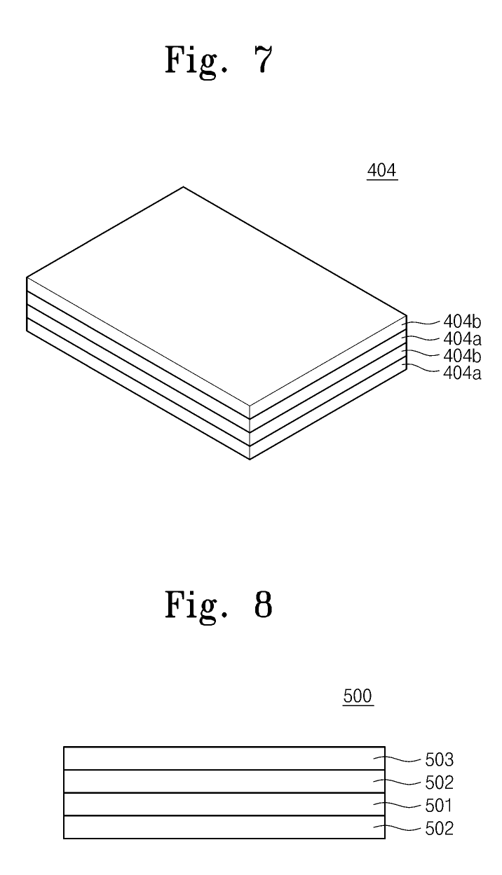

FIG. 7 is a perspective view showing a brightness-enhancement film applied to the first polarizer of FIG. 5C.

Referring to FIG. 7, the brightness-enhancement film 404 has a multi-layered structure in which two different layers 404a and 404b are alternately stacked. For instance, the two different layers 404a and 404b may include polyethylene naphtalate having a high briefringence and polymethylmethacrylate having an isotropic structure, respectively. The brightness-enhancement film 404 may include dual brightness enhancement film (DBEF), such as that sold by 3M Co. The brightness-enhancement film 404 may be formed integrally with or separately from the first polarizer 400. That is, the brightness-enhancement film 404 may be removed from the first polarizer 400, and then disposed between the first polarizer 400 and the backlight unit 300.

The low-reflection layer 410 is disposed at the lower portion of the brightness-enhancement film 404 to prevent the re-reflection of the light incident into the low-reflection layer 410. As described above, when the brightness-enhancement film 404 is applied to the liquid crystal display, the brightness of the liquid crystal display is remarkably enhanced. Thus, when the low-reflection layer 410 is not applied to the liquid crystal display including the brightness-enhancement film 404, the vertical striped pattern may appear more vividly since the brightness of the light re-reflected by the first polarizer 400 increases.

In the above-described embodiments of FIG. 5A, FIG. 5B, and FIG. 5C, the low-reflection layer 410 is disposed at a lowermost position of the first polarizer 400. However, the low-reflection layer 410 may alternatively be disposed at various positions inside the first polarizer 400. For example, the low-reflection layer 410 may be disposed between the first supporting film 402 and the brightness-enhancement film 404. In this case, a refractive-index difference between the parts constituting the first polarizer 400 should be small, so that the reflection of light at the interface between the parts is minimal. However, since the lower face of the first polarizer 400 contacts an external medium, the refractive-index difference may be high, and thus the reflection of light increases. Accordingly, when the low-reflection layer 410 is disposed at the lowermost position of the first polarizer 400, the display quality of the liquid crystal display may be remarkably improved since the reflection of light from the lower face of the first polarizer 400 is blocked by the low-reflection layer 410.

FIG. 8 is a sectional view showing a second polarizer of FIG. 1.

Referring to FIG. 8, the second polarizer 500 includes a second polarizing film 501, a second supporting film 502, and a surface protection film 503. The second polarizing film 501 polarizes the light in one direction. The second polarizer 500 includes a pair of the supporting films 502 to support the second polarizing film 501, which is interposed between the supporting films 502.

The surface protection film 503 is disposed at an uppermost position of the second polarizer 500 and protects an inner portion of the second polarizer 500 from external impact. Also, the surface protection film 503 may be treated to have various properties, such as anti-static, anti-glare, and so on. The anti-static treatment prevents static electricity from being generated inside the liquid crystal display, and the anti-glare treatment causes diffused reflection of light from the surface of the liquid crystal display to prevent the surface of the liquid crystal display from appearing to dazzle. The anti-glare treatment causes the diffused reflection of light provided from the backlight unit 30, which may otherwise cause the appearance of a vertical striped pattern.

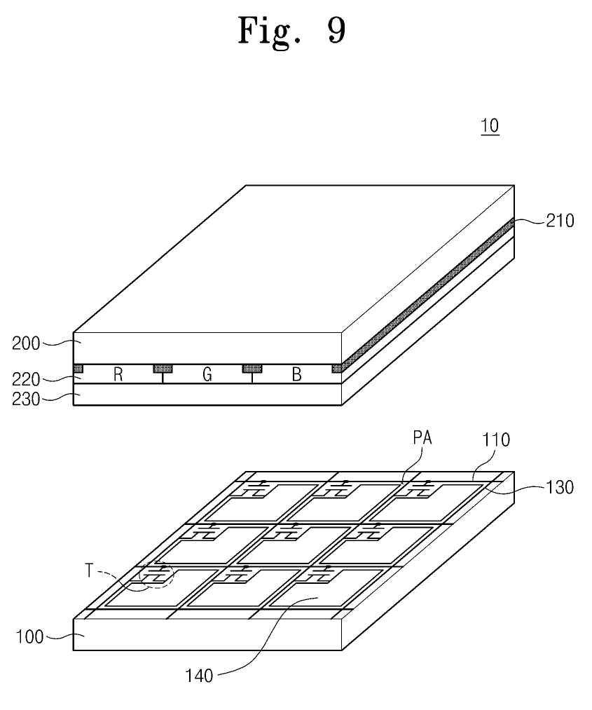

FIG. 9 is a perspective view showing the liquid crystal display panel of FIG.

Referring to FIG. 9, the first substrate 100 includes a plurality of gate lines 110 and a plurality of data lines 130 disposed thereon. The gate lines 110 cross and are insulated from the data lines 130 to define a plurality of pixel areas on the first substrate 100. A thin film transistor T and a pixel electrode 140 are disposed in each pixel area PA. The thin film transistor T includes a control electrode connected to a corresponding gate line among the gate lines 110, an input electrode connected to a corresponding data line among the data lines 130, and an output electrode facing the input electrode.

The second substrate 200 includes a light-blocking layer pattern 210 through which portions corresponding to the pixel areas PA are opened. A color filter 220 is disposed on the light-blocking pattern 210 and fills the opened portions. The color filter 220 includes a red color filter R, a green color filter G, and a blue color filter B, and the red, green, and blue color filters R, G, and B are alternately arranged along the pixel areas PA. The liquid crystal display displays images having various colors through the combination of the red, green, and blue color filters R, G, and B. A common electrode 230 is disposed over the color filter 220.

The thin film transistor T turns on in response to a gate signal applied to the corresponding gate line. The pixel electrode 140 receives a data voltage from a data signal applied to the corresponding data line. The common electrode 230 receives a common voltage having a constant voltage level. Due to a voltage difference between the data voltage and the common voltage, an electric field is generated between the first and second substrates 100 and 200. Liquid crystals of the liquid crystal layer 300 are arranged in various directions according to the electric field. As described above, by controlling the arrangement direction of the liquid crystals, the amount of the light passing through the second polarizer 500 may be adjusted, so that a desired image may be displayed.

In the present exemplary embodiment, the gate lines 110, the control electrode connected to the gate lines 110, the data lines 130, the input electrode connected to the data lines 130, and the output electrode facing the input electrode may make up the thin film pattern 11 that partially transmits light. In other words, the gate lines 110, the control electrode, the data lines 130, the input electrode, and the output electrode may include a conductive metallic material, and the conductive metallic material may block and reflect the light.

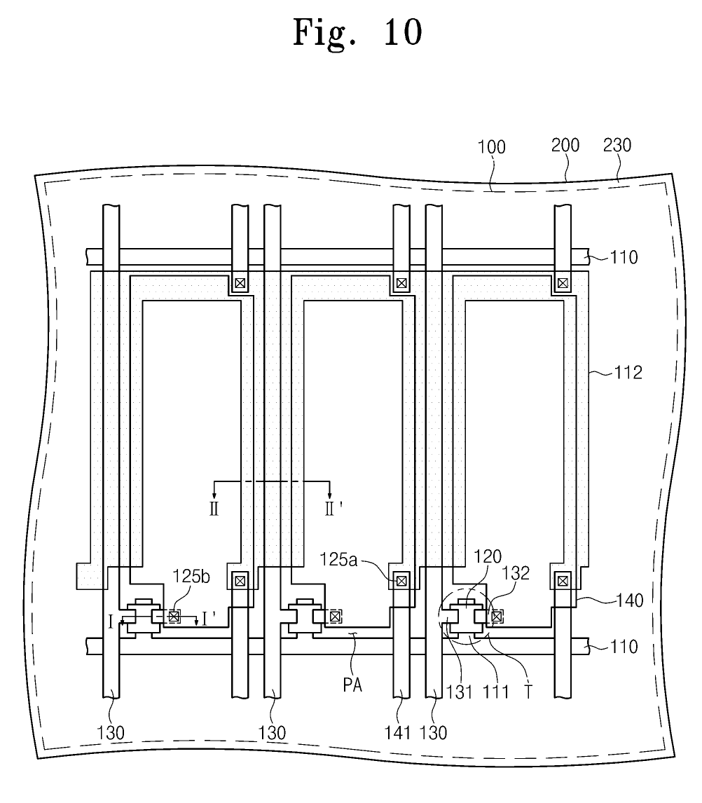

FIG. 10 is a plan view showing a liquid crystal display according to another exemplary embodiment of the present invention.

In FIG. 10, the liquid crystal display includes a liquid crystal display panel, a polarizer, and a backlight unit that each have the same structure as those of the above-described exemplary embodiments. Thus, drawings and descriptions of the polarizer and the backlight unit will be omitted, and only the liquid crystal display panel will be shown in FIG. 10. In the present exemplary embodiment, the same reference numerals denote the same elements as those of the above-described exemplary embodiments, and thus structures and functions of the same elements will be omitted.

Referring to FIG. 10, the liquid crystal display includes a first substrate 100 and a second substrate 200. The first substrate 100 includes gate lines 110 and data lines 130 disposed thereon. The gate lines 110 and the data lines 130 define pixel areas PA each in which a storage electrode 112, a thin film transistor T, and a pixel electrode 140 are arranged. The storage electrode 112 overlaps the data lines 130 when viewed in a plan view and has a width greater than that of the data lines 130. The storage electrode 112 includes portions formed parallel to the gate lines 110, and storage electrodes adjacent to each other in a horizontal direction are connected to each other by the portions disposed parallel to the gate lines 110. Also, the storage electrodes adjacent to each other in a vertical direction are connected to each other by a connection electrode 141 connected to a first contact hole 125a. The connection electrode 141 is disposed on the same layer as the pixel electrode 140 and may include the same material as the pixel electrode 140. The thin film transistor T includes a control electrode 111, a semiconductor layer pattern 120, an input electrode 131, and an output electrode 132. The second substrate 200 includes a common electrode 230 disposed thereon and facing the pixel electrode 140.

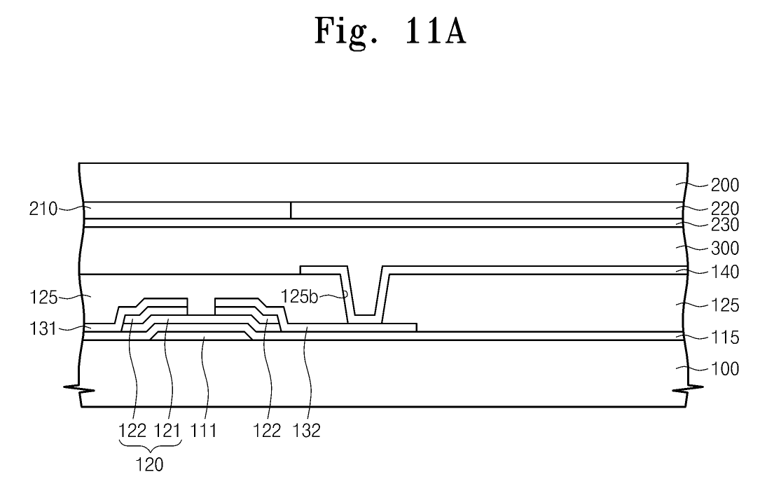

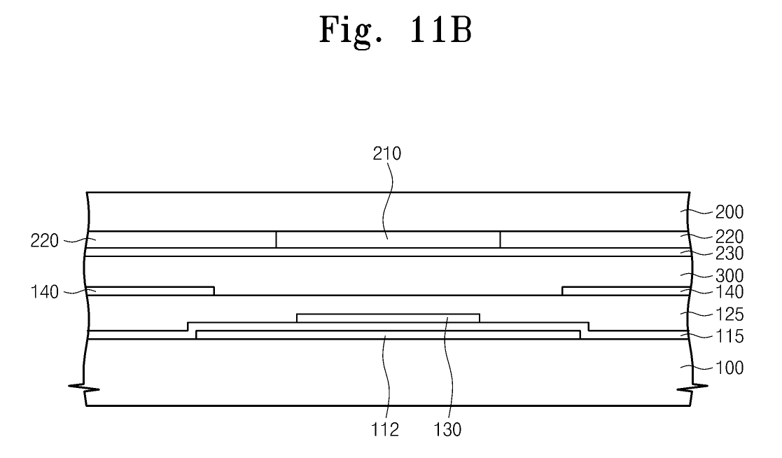

FIG. 11A is a cross-sectional view taken along line I-I′ of FIG. 10.

Referring to FIG. 11A, a first insulating layer 115 and a second insulating layer 125 are sequentially disposed between the control electrode 111 and the pixel electrode 140. The first insulating layer 115 is disposed on the control electrode 111 to entirely cover the first substrate 100. The second insulating layer 125 is disposed on the input electrode 131 and the output electrode 132 to entirely cover the first substrate 100. The second insulating layer 125 is provided with a second contact hole 125b formed therethrough to partially expose the output electrode 132. The pixel electrode 140 is connected to the output electrode 132 through the second contact hole 125b. The thin film transistor T further includes the semiconductor layer pattern 120. The semiconductor layer pattern 120 includes an active layer 121 and an ohmic contact layer 122. The ohmic contact layer 122 is disposed on the active layer 121 and separated into two parts respectively corresponding to the input electrode 131 and the output electrode 132.

The light-blocking layer pattern 210 in which portions corresponding to the pixel areas PA are opened is disposed on the second substrate 200. The opened areas of the light-blocking layer pattern 210 are filled with the color filter 220. The common electrode 230 is disposed on the color filter 220.

FIG. 11B is a cross-sectional view taken along line II-II′ of FIG. 10.

Referring to FIG. 11B, the storage electrode 112 and the data line 130 are disposed between the pixel areas PA, and the pixel electrode 140 is disposed in the pixel areas PA and a portion of the pixel electrode 140 is disposed between the pixel areas PA. The storage electrode 112 serves two functions as follows.

The storage electrode 112 partially overlaps the pixel electrode 140 in a plan view. The first and second insulating layers 115 and 125 are disposed between the storage electrode 112 and the pixel electrode 140. The storage electrode 112 overlaps the pixel electrode 140 and the first and second insulating layers 115 and 125 interposed between the storage electrode 112 and the pixel electrode 140 form a storage capacitor. The storage capacitor maintains a data voltage corresponding to the image displayed on the liquid crystal display panel during a specified duration.

The storage electrode 112 is disposed together with the gate line 110 and the control electrode 111 on the first substrate 100. The storage electrode 112, the gate line 110, and the control electrode 111 may also include a conductive metallic material to block light. Accordingly, the storage electrode 112 may block light passing through the region between the pixel areas PA.

The maintenance of the data voltage is not the main function of the storage electrode 112, and the light-blocking function of the storage electrode 112 may be performed by the light-blocking layer pattern 210. Thus, the storage electrode 112 may be omitted from the liquid crystal display. However, in order to omit the storage electrode 112 from the liquid crystal display and block light using the light-blocking layer pattern 210, the light-blocking layer pattern 210 must be positioned at a region between the pixel areas PA. In this case, since the pixel areas PA are defined on the first substrate 100 and the light-blocking layer pattern 210 is disposed on the second substrate 200, the light-blocking layer pattern 210 may deviate from the region between the pixel areas PA due to misalignment during the fabrication process for the liquid crystal display. In order to prevent a deviation in the light-blocking layer pattern 210, the width of light-blocking layer pattern 210 should be sufficient to obtain a margin against misalignment of the light-blocking layer pattern 210. However, when the width of the light-blocking layer pattern 210 increases, the pixel areas PA, on which the image is displayed, decrease and the aperture ratio also decreases.

However, when blocking light passing through the region between the pixel areas PA using the storage electrode 112 disposed on the first substrate 100, defects caused by misalignment may be minimized. Accordingly, the width of storage electrode 112 may be small, so that the aperture ratio of the liquid crystal display may increase. For instance, when the light-blocking layer pattern 210 has the width of about 15 micrometers, the storage electrode 112 may have a width that is equal to or larger than about 15 micrometers. For example, the storage electrode 112 may have a width of about 25 micrometers or about 20 micrometers. A portion of the storage electrode 112, which is disposed parallel to the gate line 110, may have a smaller width than a portion of the storage electrode 112, which overlaps the data line 130, in order to minimize reduction of the aperture ratio.

According to the above, the low-reflection layer is attached on the lower face of the polarizer of the liquid crystal display panel. Thus, the light reflected by the metallic thin film patterns disposed on the first and second substrates 100 and 200 may be prevented from being re-reflected by the polarizer, which may prevent the display quality of the liquid crystal display from deteriorating.

It will be apparent to those skilled in the art that various modifications and variations can be made in the present invention without departing from the spirit or scope of the invention. Thus, it is intended that the present invention cover the modifications and variations of this invention provided they come within the scope of the appended claims.

What is claimed is:

1. A liquid crystal display, comprising:
a backlight unit to generate a light;
a liquid crystal display panel to receive the light to display an image, the liquid crystal display panel comprising a first optical layer that partially reflects the light;
a first polarizer coupled to a lower portion of the liquid crystal display panel and facing the backlight unit, the first polarizer comprising a second optical layer;
a second polarizer coupled to an upper portion of the liquid crystal display panel and corresponding to the first polarizer; and
wherein the second optical layer prevents light reflected by the first optical layer from being re-reflected back to the liquid crystal display panel.

2. The liquid crystal display of claim 1, wherein the second optical layer is positioned at an outermost position of the first polarizer and is exposed outwardly.

3. The liquid crystal display of claim 1, wherein the second optical layer comprises a low-reflection layer.

4. The liquid crystal display of claim 3, wherein the low-reflection layer causes a phase difference of about ¼ wavelength with respect to the light passing through the low-reflection layer.

5. The liquid crystal display of claim 1, wherein the second optical layer comprises a light scattering layer.

6. The liquid crystal display of claim 1, wherein the first polarizer further comprises a brightness-enhancement film to enhance a brightness of the light applied from the backlight unit.

7. The liquid crystal display of claim 6, wherein the brightness-enhancement film comprises a multi-layered structure in which two different types of layers are alternately stacked.

8. The liquid crystal display of claim 1, wherein the liquid crystal display panel further comprises:
a first substrate to which the first polarizer is coupled to and on which a pixel area is defined;
a gate line disposed on the first substrate;
a data line crossing the gate line to define the pixel area;
a second substrate to which the second polarizer is coupled to;
a light-blocking layer pattern disposed on the second substrate and positioned in regions corresponding to the gate line and the data line; and
a liquid crystal layer interposed between the first substrate and the second substrate.

9. The liquid crystal display of claim 8, wherein the first optical layer is disposed on the same layer as the gate line, and the first optical layer completely overlaps the data line.

10. The liquid crystal display of claim 9, wherein the first optical layer completely overlaps the light-blocking layer pattern.

11. The liquid crystal display of claim 10, wherein the first optical layer has a width in a range of about 15 micrometers to about 25 micrometers.

12. The liquid crystal display of claim 10, wherein the liquid crystal display panel further comprises:
a pixel electrode disposed on the first substrate to receive a data voltage; and
a common electrode disposed on the second substrate and to receive a common voltage.

13. A polarizer, comprising:
a polarizing film to polarize a light;
a brightness-enhancement film coupled to the polarizing film to enhance a brightness of the light; and
a low-reflection layer coupled to the brightness-enhancement film to prevent the light from being rereflected back to the polarizing film.

14. The polarizer of claim 13, wherein the brightness-enhancement film comprises a multi-layered structure in which two different types of layers are alternately stacked.

15. The polarizer of claim 13, wherein the low-reflection layer is positioned at an outermost position the polarizer and exposed outwardly.

16. The polarizer of claim 15, wherein the low-reflection layer causes a phase difference of about ¼ wavelength with respect to light passing through the low-reflection layer.
